(19) United States
(12) Patent Application Publication
(10) Pub. No.: US 2007/0163863 A1
(43) Pub. Date: Jul. 19, 2007

(54) Water resistant keycard reader assembly for an electronic lock

(75) Inventors: Ernst Kern Mitchell, Sterling Heights, MI (US); Bryan Michael Urben, Troy, MI (US); Charles W. Moon, Colorado Springs, CO (US)

Correspondence Address: CARLSON, GASKEY & OLDS, P.C., 400 WEST MAPLE ROAD, SUITE 350, BIRMINGHAM, MI, 48009, US

(73) Assignee: Computerized Security Systems, Inc.

(21) Appl. No.: 11/333,141

(22) Filed: Jan. 17, 2006

(51) Int. Cl. H01H 27/00

(52) U.S. Cl. 200/43.04

(57) ABSTRACT

An electronic lock includes a keycard sensing assembly which interacts with a keycard sensing switch surface mounted to a circuit board. The keycard sensing assembly is located adjacent a rear of a keycard slot such that when a key card is fully inserted into the keycard slot, the keycard activates the keycard sensing assembly. Such an arrangement permits a significant portion of the circuit board to be potted within a potting compound such that the keycard reader becomes essentially waterproof. Such a construction permits the insertion of a wet or damp keycard without concern for water damage to the keycard sensing assembly.

### BACKGROUND OF THE INVENTION

The present invention relates to door locks, and more particularly to door locks having an electronic key card reader.

Door locks in properties such as hotels often use electronic key cards rather than mechanical keys to control operation of a lock. Electronic key cards and electronic locks are individually programmable and provide significant security in a convenient manner.

Electronic locks are typically self-powered through an internal battery. In addition to the electronic lock operational components, electronic locks provide visual feedback in the form of indicator lights that illuminate in response to card insertion and/or removal. All of these electrical components are powered by the internal battery. To maximize the operational life of the battery so as to minimize maintenance of the electronic lock, a keycard sensing switch powers up the electronics of the electronic lock only in response to insertion and contact with a keycard. Disadvantageously, hotel guests and the like often insert keycards which have been submersed in water such as from the guest being in a pool or spa. Although not damaging to the keycard, repeated introduction of moisture into the interior of the electronic lock may render the keycard sensing switch or other electronic components in communication with the keycard slot inoperable. Failure of an electronic lock component may render the entire electronic lock inoperable.

Accordingly, it is desirable to provide a moisture resistant electronic lock.

### SUMMARY OF THE INVENTION

An electronic lock according to the present invention includes a keycard sensing assembly which interacts with a keycard sensing switch is mounted directly to a surface of a circuit board. The keycard sensing assembly is located adjacent a keycard slot such that when a key card is fully inserted into the keycard slot, the keycard activates the keycard sensing assembly. Such an arrangement permits a significant portion of the circuit board to be potted within a potting compound such that the keycard reader becomes essentially waterproof. Such a construction permits the insertion of a wet or damp keycard without concern for water damage to the electronics.

The keycard sensing assembly generally includes a switch activator and a switch activator spring. The switch activator is a generally L-shaped member having a first arm generally transverse to a second arm. The second arm extends transverse to the keycard slot while the first arm extends generally parallel thereto and over the keycard sensing switch.

When the keycard is inserted fully into the keycard slot, the keycard engages the second arm, overcomes the bias of the switch activator spring and pivots the switch activator about a pivot axis such that the first arm activates the keycard sensing switch. The switch activator provides a greater range of motion than the switch such that actuation is assured. The spring flexes when the full switch range of motion has been reached so as to accommodate lost motion. Switch actuation is therefore assured yet even significant force on the keycard will not damage the switch.

The present invention therefore provides a moisture resistant electronic lock.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of an exemplary electronic lock system used with the present invention;

FIG. 2 is a block diagram of the electronic lock system of the present invention;

FIG. 3 is an exploded view of a keycard reader assembly designed according to the present invention;

FIG. 4 is a sectional view of the keycard reader assembly taken along a length of a keycard slot;

FIG. 5 is an expanded perspective view of a switch activator;

FIG. 6 is a rear bottom perspective view of the keycard reader;

FIG. 7 is perspective view of the switch activator mounted to the keycard reader assembly.

### DETAILED DESCRIPTION OF THE PREFERRED EMBODIMENT

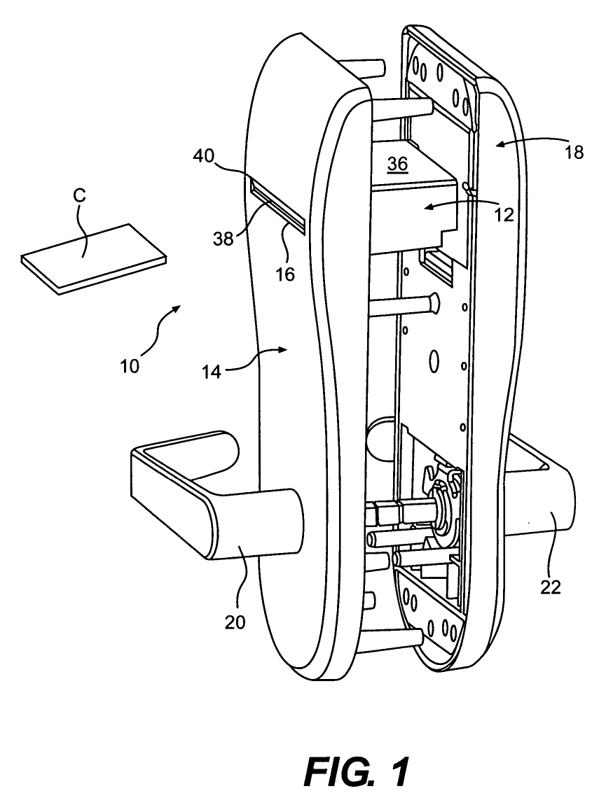

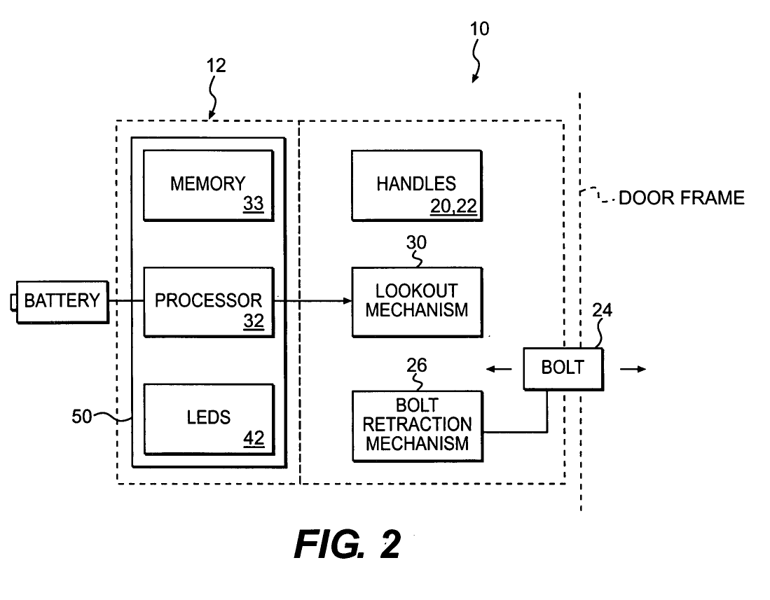

FIG. 1 illustrates a general perspective view of a lock 10 having a keycard reader 12. The lock 10 includes a front trim panel 14 having a trim slot 16 through which an electronic key card C is received. A corresponding rear trim panel 18 is attachable to the front trim panel 14 with the keycard reader 12 mounted therebetween. The rear trim panel 18 is oriented by a door toward the interior of a room when the lock 10 is installed and therefore does not include a keycard slot like the front trim panel 14. Manually operable door handles 20, 22 operate a retractable latch bolt 24 (FIG. 2) in any conventional manner in response to a valid electronic key card.

As schematically represented in block form at FIG. 2, the keycard reader 12 is operably coupled to the retractable latch bolt 24 via any desired bolt retraction mechanism 26. The latch bolt 24 is operably connected to the handles 20, 22 so that the latch bolt 24 is movable between an extended position and a retracted position by turning one of the handles 20, 22. The latch bolt 24 is movable between an extended position, where the latch bolt 24 engages with a corresponding recess in a door frame, and a retracted position, where the latch bolt 24 is withdrawn from the door frame so that the door can be opened. The handles 20, 22 may be operably engaged with the latch bolt 24 through conventional structure such as a spindle that translates the rotational movement of the handles 20, 22 into linear movement of the latch bolt 24. Alternatively or additionally, an electric drive may be utilized.

The keycard reader 12 generally includes a processor 32 and memory 33 which communicates with the latch bolt 24 such that insertion of a correctly encoded key card C into the keycard reader 12 permits the latch bolt 24 to be retracted. It should be understood that the processor 32 and memory 33 may include a clock, access tracking information, card reading instructions, and lock operating instructions as program sets stored within the memory 33 and operated thereupon by the processor 32.

The specific way in which the keycard reader 12 and the latch bolt 24 interact to move the latch bolt 24 between the locked and unlocked positions may be via any known actuator mechanism without departing from the scope of the invention. If a correctly encoded key card is not inserted into the keycard reader 12, a motor-driven electronic lockout mechanism 30 mechanically prevents the handles 20, 22 from operating the latch bolt 24. The lockout mechanism 30 may also operably disconnect the bolt retraction mechanism 26 from the handles 20, 22 or otherwise block the bolt retraction mechanism 26 so that the latch bolt 24 will not retract even if the handles 20, 22 are turned. In other words, the lockout mechanism 30 controls whether the latch bolt 24 is an operable state or an inoperable state in response to the processor 32.

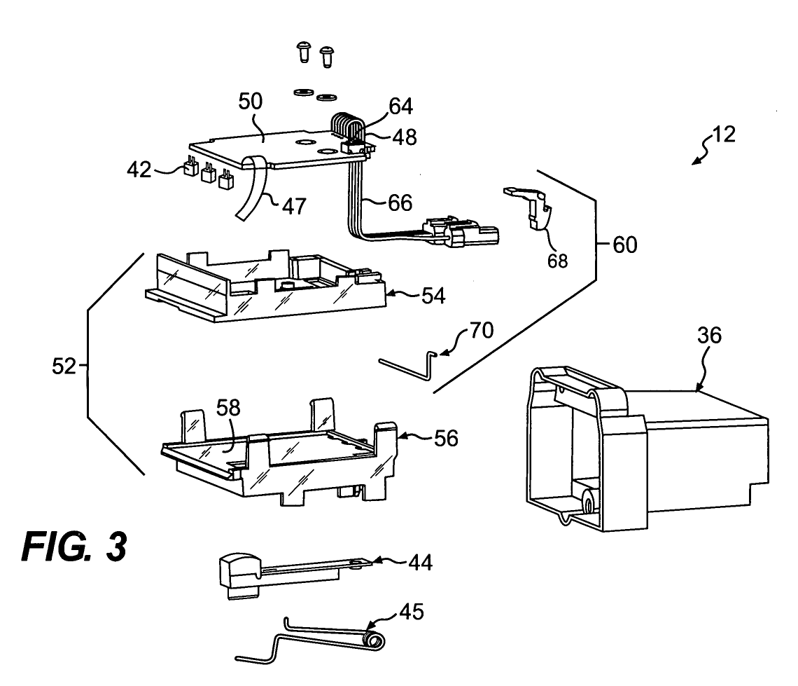

Referring to FIG. 3, the keycard reader 12 includes a housing 36 which defines a card slot opening 38 and a front edge 40 that may be exposed through the trim slot 16 (FIG. 1). The card slot opening 38 is sized to accommodate the electronic key card C such that the front edge 40 surrounds at least the top and bottom longitudinal sides of the card slot opening 38. The housing 36 is preferably manufactured of a metallic material to minimize tampering of the components therein.

An inner housing assembly 52 supports at least one light source 42 such as light emitting diodes (LEDs) which are mounted directly to a circuit board 50 and a read head assembly 44 such as a magnetic read head and/or a smart card read head. A keycard sensing switch 48 is located to detect when a card C is properly inserted into the card slot opening 38 formed by the inner housing assembly 52. The various components of the keycard reader 12 can be powered by any desired method, such as through a replaceable or rechargeable battery or though direct hard wiring to an external power source.

The keycard reader 12 generally includes the circuit board 50 mounted to the inner housing assembly 52. By mounting the light source 42, the processor 32 and the memory 33 directly onto the circuit board 50 and by using a light transmitting material in at least a portion of the inner housing assembly 52, the keycard reader 12 serves as both a keycard reader and a visual interface, eliminating the need for a separate visual interface. Preferably, the entirety of the inner housing assembly 52 is manufactured of a translucent light transmitting material. The front trim panel 14 (FIG. 1) therefore need only provide a single opening to provide both access to the keycard reader 12 and visual feedback, without any separate openings or lenses for a visual interface.

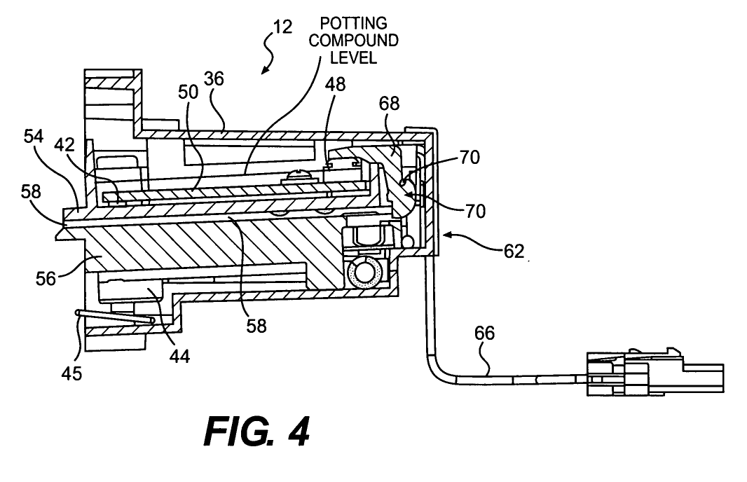

The inner housing assembly 52 generally includes an upper inner housing 54 which supports the circuit board 50 and a lower inner housing 56 which supports the read head assembly 44. The upper inner housing 54 and the lower inner housing 56 are preferably manufactured of a light transmitting material such as translucent or transparent plastic. The interface between the upper inner housing 54 and the lower inner housing 56 defines a keycard slot 38 (also illustrated in FIG. 4) for receipt of the keycard C. It should be understood that other light transmitting materials may also be utilized.

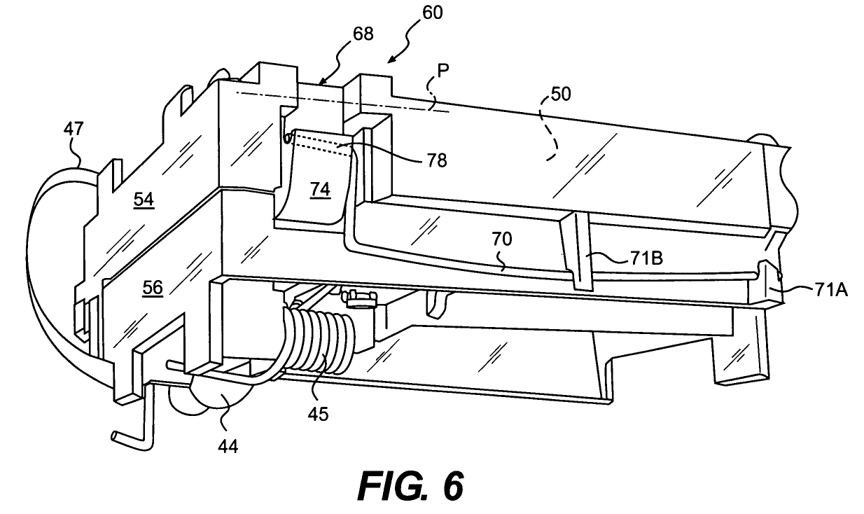

The lower inner housing 56 supports the read head assembly 44. A read head spring 45 biases the read head assembly 44 toward the keycard slot 38. A flexible printed circuit 47 preferably provides for communication between the read head assembly 44 and the circuit board 50 (also illustrated in FIG. 6).

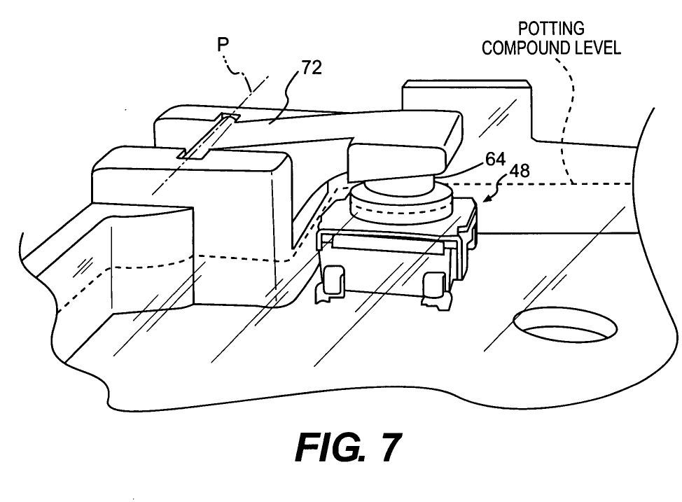

The inner housing assembly 52 supports a keycard sensing assembly 60 having a switch activator 68 and a switch activating spring 70. The keycard sensing assembly 60 provides remote activation of the keycard sensing switch 48 such that the keycard sensing switch 48 is directly surface mounted to the circuit board 50. The keycard sensing assembly 60 is preferably mounted adjacent a rear 62 of the inner housing assembly 54 (FIG. 4) such that when the key card C is fully inserted into the slot 58, the keycard C activates the keycard sensing assembly 60 and the keycard sensing switch 48. Such an arrangement permits the circuit board 50 including the light source 42 to be completely potted within a potting compound (FIG. 7) such that the keycard reader 12 becomes essentially waterproof. That is, the switch 48 is arranged upward such that the button 64 lies above the potting compound level while seams and solder connections of the switch 48 as well as other components on the board 50 lie below the potting compound level such that they are encapsulated and thereby protected from moisture and other contaminants.

Most preferably, the potting compound is a translucent light transmitting material such that the light source 42 may be completely contained within the potting compound. As the inner housing assembly 54 and the potting compound are manufactured of a light transmitting material, the light source 42, may be located between the circuit board 50 and the upper inner housing 54 such that the light source 42 will illuminate the key card slot 58 there through (FIG. 4).

Only a movable button portion 64 of the keycard sensing switch 48, a flexible printed circuit 47 and the wiring harness 66 need extend from the potting compound. The wiring harness 66 is preferably a mil-spec wiring harness which is resistant to water and most preferably provides a completely waterproof plug connection. Such construction permits the insertion of a wet or damp keycard C without concern for water damage within the keycard reader 12.

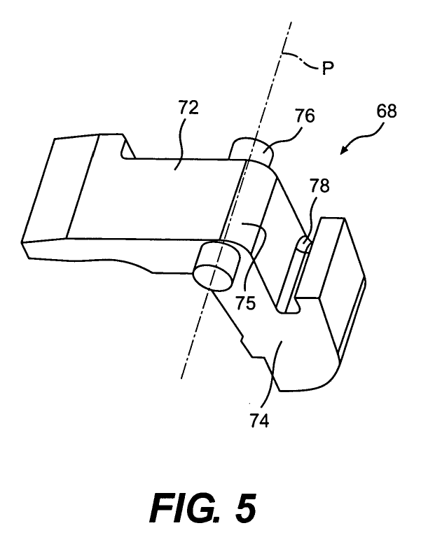

Referring to FIG. 5, the switch activator 68 is a generally L-shaped member having a first arm 72 generally transverse to a second arm 74. The first arm 72 is mounted to extend generally parallel to and above the board 50 while the second arm 74 extends generally perpendicular to the board 50 (FIG. 4). A pivot pin 76 is located generally at an intersection 75 between the first arm 72 and the second arm 74. The second arm 74 further includes a spring receipt catch 78 to receive the switch activator spring 70 (FIG. 6).

Referring to FIG. 6, the switch activator 68 is mounted to the rear 62 of the inner housing assembly 54 about a pivot axis P generally parallel to the circuit board 50. That is, the second arm 74 extends transverse to the keycard slot 38 while the first arm 72 extends generally parallel thereto and over the keycard sensing switch 48. The spring 70 includes a generally stepped-shaped which is retained between hooks 71A, 71B on the upper inner housing 54 and the spring receipt catch 78 on the switch actuator 68 such that a bias is placed on the switch activator 68. That is, the spring 70 biases the switch activator 68 such that the first arm 72 is biased away from the keycard sensing switch 48 about the pivot axis P (FIG. 7). Contact between the second arm 74 and the inner housing assembly 54 maintains the unactuated position of the switch activator 68.

When the keycard C is inserted fully into the keycard slot 38, the keycard C engages the second arm 74, overcomes the bias of spring 70 and pivots the switch activator 68 about the pivot axis P such that the first arm 72 activates the keycard sensing switch 48. The switch activator 68 preferably provides a greater range of motion than the keycard sensing switch 48 such that actuation is assured. The spring 70 flexes when the full switch range of motion has been reached so as to accommodate this lost motion. That is, once the movable button 64 of the keycard sensing switch 48 has reached full travel, the spring 70 will flex in response to further travel of the keycard C toward the rear 62 of the keycard slot 38. Switch actuation is therefore assured yet even relatively significant force on the keycard C will not result in damage to the keycard sensing switch 48.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An electronic keycard reader assembly comprising:
a circuit board mounted adjacent a keycard slot;
a keycard sensing switch mounted to said circuit board; and
a switch activator assembly mounted adjacent said keycard slot, said keycard activator assembly operable to actuate said keycard sensing switch in response to receipt of a keycard within said keycard slot.

2. The assembly as recited in claim 1, wherein said switch activator assembly is pivotally mounted to a housing, said switch activator mounted opposite a keycard opening of said keycard slot.

3. The assembly as recited in claim 2, wherein said switch activator assembly includes a spring biased switch activator.

4. The assembly as recited in claim 3, wherein said spring biased switch activator accommodates lost motion of said keycard within said keycard slot.

5. The assembly as recited in claim 2, wherein said switch activator is generally L-shaped.

6. The assembly as recited in claim 5, wherein said spring biased switch activator accommodates lost motion of said keycard within said keycard slot.

7. The assembly as recited in claim 2, wherein said switch activator includes a first arm transverse to a second arm, said first arm adjacent said keycard sensing switch and said second arm transverse to said keycard slot.

8. The assembly as recited in claim 7, wherein said spring biased switch activator accommodates lost motion of said keycard within said keycard slot.

9. The assembly as recited in claim 1, wherein said circuit board is potted within a potting compound.

10. The assembly as recited in claim 9, further comprising a light source mounted to said circuit board, said light source at least partially illuminates an area adjacent said keycard slot.

11. The assembly as recited in claim 10, wherein said light source is potted within a transparent potting compound.

12. The assembly as recited in claim 11, wherein said switch activator assembly is pivotally mounted to a light transmitting housing, said light source mounted to said circuit board opposite a keycard slot such that said light source illuminates said keycard slot through said light transmitting housing.

13. The assembly as recited in claim 12, wherein said light source are surface mounted LEDs.

14. The assembly as recited in claim 1, wherein said keycard sensing switch includes a switch button actuator which faces away from said keycard slot.

15. The assembly as recited in claim 14, wherein said switch activator assembly is pivotally mounted to a housing, said switch activator mounted opposite a keycard opening of said keycard slot.

16. The assembly as recited in claim 15, wherein said switch activator assembly includes a spring biased switch activator.

17. The assembly as recited in claim 16, wherein said spring biased switch activator accommodates lost motion of said keycard within said keycard slot.

18. The assembly as recited in claim 15, wherein said switch activator is generally L-shaped.

19. The assembly as recited in claim 18, wherein said spring biased switch activator accommodates lost motion of said keycard within said keycard slot.

20. An electronic keycard reader assembly comprising:
a housing having a light transmitting housing portion;
a keycard sensing switch mounted adjacent a keycard slot defined by said housing; and
a switch activator assembly mounted to said housing opposite a keycard opening of said keycard slot, said keycard activator assembly operable to actuate said keycard sensing switch in response to receipt of a keycard within said keycard slot.

21. The assembly as recited in claim 20, further comprising a circuit board, said keycard sensing switch surface mounted to said circuit board.

22. The assembly as recited in claim 21, wherein said keycard sensing switch includes a switch button actuator which faces away from said keycard slot.

23. The assembly as recited in claim 21, wherein said entire circuit board is potted with a substantially light transmitting potting compound.

24. The assembly as recited in claim 21, further comprising a light source mounted to said circuit board, said light source at least partially illuminates said keycard slot through said light transmitting housing portion.

25. An electronic keycard reader assembly comprising:
a housing having a light transmitting housing portion;
a circuit board potted to said housing with a light transmitting potting compound;
a light source mounted to said circuit board, said light source at least partially illuminates said keycard slot through said light transmitting housing portion.

26. The assembly as recited in claim 25, further comprising a switch activator assembly mounted to said housing opposite a keycard opening of said keycard slot, said keycard activator assembly operable to actuate said keycard sensing switch in response to receipt of a keycard within said keycard slot.

27. The assembly as recited in claim 21, wherein said switch activator assembly is pivotally mounted to a housing, said switch activator mounted opposite a keycard opening of said keycard slot.

28. The assembly as recited in claim 27, wherein said switch activator assembly includes a spring biased switch activator.

29. The assembly as recited in claim 28, wherein said spring biased switch activator accommodates lost motion of said keycard within said keycard slot.

30. The assembly as recited in claim 27, wherein said switch activator is generally L-shaped.

31. The assembly as recited in claim 30, wherein said spring biased switch activator accommodates lost motion of said keycard within said keycard slot.

32. An electronic keycard reader assembly comprising:
a circuit board mounted adjacent a keycard slot; and
a keycard sensing switch mounted to said circuit board said keycard sensing switch including a switch button actuator which faces away from said keycard slot.

33. A method of sensing insertion of a keycard into a keycard slot comprising the steps of:
(1) biasing a switch activator away from a keycard sensing switch;
(2) overcoming the bias of the switch activator in response to insertion of a keycard; and
(3) pivoting the switch activator into contact with the keycard sensing switch.

34. A method as recited in claim 33, wherein said step (1) further comprises locating the keycard sensing switch on a circuit board opposite a keycard slot.

35. A method as recited in claim 33, wherein said step (2) further comprises:
(a) contacting an edge of the keycard with the switch activator.

36. A method as recited in claim 33, wherein said step (2) further comprises:
(a) locating the switch activator adjacent an end of the keycard slot opposite an opening of the keycard slot; and
(b) contacting an forward edge of the keycard with the switch activator.

37. A method as recited in claim 33, wherein said step (3) further comprises:
(a) contacting an edge of the keycard with a first leg of the switch activator; and
(b) contacting a second leg of the switch activator with the keycard sensing switch.

38. A method as recited in claim 33, wherein said step (2) further comprises:
(a) accommodating lost motion of the keycard within the keycard slot.
